(19) United States
(12) Patent Application Publication
(10) Pub. No.: US 2008/0284678 A1
(43) Pub. Date: Nov. 20, 2008

(54) VEHICLE DISPLAY

(76) Inventors: Robert J. Randel, West Bloomfield, MI (US); Donald O. Olmack, Clinton Township, MI (US); Gary B. Flaishans, Clarkston, MI (US); Scott P. Griesmann, Troy, MI (US); Rashmi Persaud, Rochester Hills, MI (US); Jacqueline M. Stanyer, Lake Orion, MI (US)

Correspondence Address: Ralph E Smith;CIMS 483-02-19, DaimlerChrysler Intellectual Capital Corporation, 800 Chrysler Drive East, Auburn Hills, MI, 48326-2757, US

(21) Appl. No.: 11/747,938

(22) Filed: May 14, 2007

(51) Int. Cl. G09G 3/00; G01M 17/00; G06F 19/00

(52) U.S. Cl. 345/55; 701/29

(57) ABSTRACT

A vehicle display system includes a display that includes first and second display areas. The first display area displays a plurality of first icons in a first color indicative of a first warning. The second display area displays a plurality of second icons in a second color indicative of a second warning that is different than the first color. An icon library includes the pluralities of first and second Icons. A command module selects from the pluralities of first and second icons based on one or more vehicle conditions. A first control module controls the first display area to display one of the first plurality of icons, at a time based on the selections from the command module. A second control module controls the second display area to display one of the second plurality of icons at a time based on the selections from the command module.

### FIELD OF THE INVENTION

The present disclosure relates to vehicle systems and more particularly to an instrument cluster display for a vehicle.

### BACKGROUND

Vehicles, such as automobiles, trucks, watercraft, aircraft, and the like may include instrument clusters that include displays that provide visual information to vehicle operators. The information may include, for example, a current transmission gear or a vehicle speed.

Instrument clusters may provide further information via discrete warning icons/Indicators. The warning icons are often cut-outs of an overlay that is back-lit with light emitting diodes (LEDs). The warning icons often represent vehicle conditions that have varying degrees of severity. Therefore, either respective overlays or LEDs may include different colors to distinguish different degrees of severity.

As numbers of discrete warning icons increases, so does demand for space on the instrument cluster. Further, a vehicle operator may require more time viewing an instrument cluster/display as the amount of Information provided increases.

### SUMMARY

A vehicle display system includes a display that includes a plurality of display areas. A first display area displays a first plurality of icons in a first color indicative of a warning and displays only one of the first plurality of icons at a time. A control module selects one of the first plurality of icons based on a vehicle condition.

In other features, a vehicle display system includes a display that includes first and second display areas. The first display area includes a pixel matrix and displays in a first color indicative of a warning. The second display area displays at least one of a plurality of selectable features. An icon library includes a plurality of icons. A command module selects one of the plurality of icons based on a vehicle condition and provides updated information for the plurality of selectable features. A first control module controls the pixel matrix based on the selection. A second control module controls the second display based on the updated information.

In other features, a vehicle display system includes a pixel matrix display that includes first and second pixel matrix display areas. The first pixel matrix display area displays a plurality of first icons in a first color indicative of a first warning. The second pixel matrix display area displays a plurality of second icons in a second color indicative of a second warning that is different than the first color. An icon library includes the pluralities of first and second icons. A command module selects from the pluralities of first and second icons based on one or more vehicle conditions. A first control module controls the first pixel matrix display area to display one of the first plurality of icons at a time based on the selections from the command module. A second control module controls the second pixel matrix display area to display one of the second plurality of icons at a time based on the selections from the command module.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of a motor vehicle including a vehicle display system according to the present disclosure;

FIG. 2 is a schematic diagram of a faceplate that includes a display according to the present disclosure;

FIG. 3 is a schematic diagram of a display according to the present disclosure;

FIG. 4 is a schematic diagram of vehicle systems according to the present disclosure; and

FIGS. 5A-5H are schematic diagrams of exemplary icons according to the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

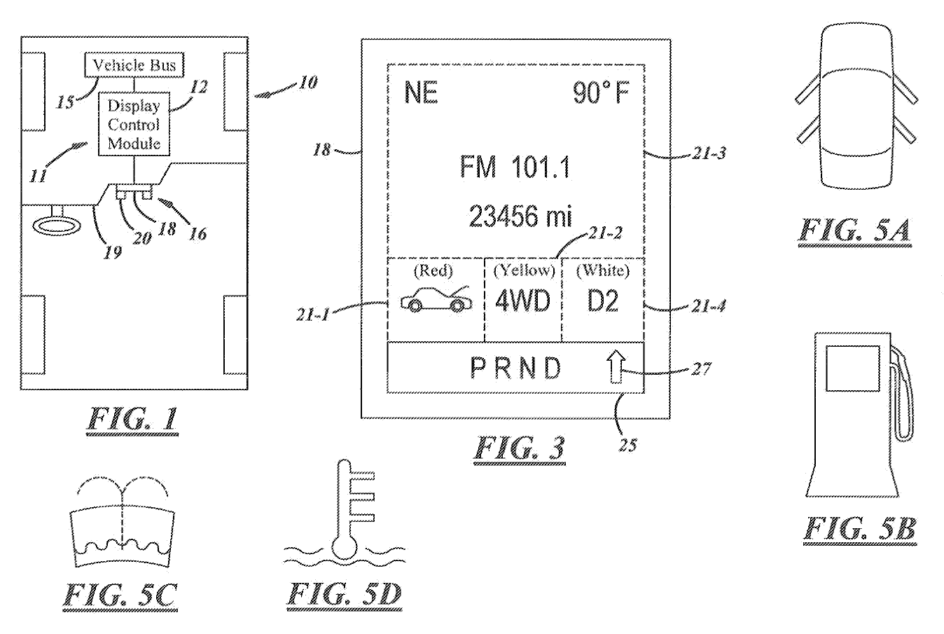

Referring now to FIG. 1, there is shown a schematic diagram of a motor vehicle 10 including a vehicle display system 11. The system 11 includes a display control module 12 communicating with a vehicle bus 15 and a faceplate 18 having a display 18. The display 18 may be included within a vehicle instrument cluster 19. A plurality of input devices 20 may control which features appear on the display 18 and may take various configurations, for example depressible buttons or rotating knobs. The display 18 may include an electronic vehicle information center (EVIC).

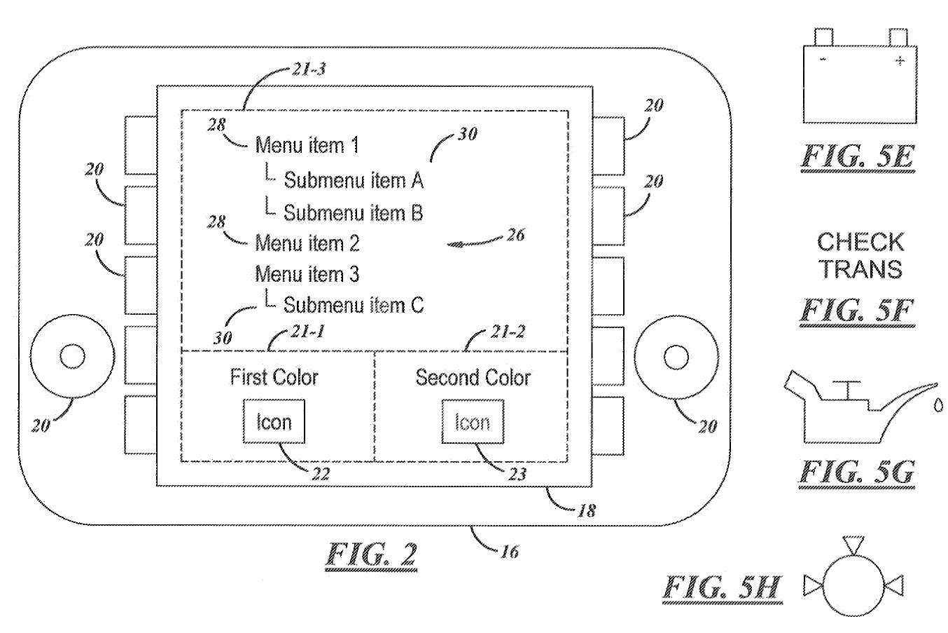

Referring now to FIG. 2, an exemplary display 18 may include a plurality of display areas. First, second, and third display areas 21-1, 21-2, 21-3 are illustrated, but numerous other display areas may also be included.

The first and second display areas 21-1, 21-2 may display first and second sets/types of icons, which may be selected from an icon library of the display control module 12. The sets of icons may or may not overlap. Both display areas 21-1, 21-2 may display a single icon 22, 23 at any given time. In the event that the control module commands that multiple icons be displayed in either or both of the display areas 21-1, 21-2 respectively, the display areas 21-1, 21-2 may periodically cycle between icons. The display areas 21-1, 21-2 may display icons in a pixel format, for example, a pixel matrix, which may be a dot matrix.

For example, two vehicle conditions may be occurring simultaneously. Both the vehicle conditions may correspond to icons from the set of icons that are represented in the first area 21-1, such as when the vehicle battery is low and the vehicle is extremely low on gas. The control module 12 may select appropriate icons for these vehicle conditions. The display area 21-1 may then show only the icon that represents a low battery condition for a predetermined amount of time, for example, 3 seconds, and then may show only the icon that represents a low gas condition.

The icons may be standard automotive icons that represent driver notifications. The driver notifications may be warnings. The warnings may be classed as having a higher importance and a lower importance. For example, an icon for low windshield wiper fluid may be classed as a warning having a lower importance while an icon for low battery may be classed as having a higher importance. The first display area 21-1 may be dedicated to icons representing warnings having a higher importance, and the second display area 21-2 may be dedicated to icons having a lower importance.

The first and second display areas 21-1, 21-2 may have dedicated color schemes. For example, the first display area 21-1 may always display icons in red, and the second display area 21-2 may always display icons in yellow. Red and yellow are used as exemplary colors as they are conventionally used in vehicles to represent warnings/notifications of higher and lower importance respectively.

The third display area 21-3 may display a plurality of selectable features. The selectable features may include, among other features, a compass, a temperature, an odometer, a radio station, an average fuel economy, a distance until empty, a navigation instruction, an elapsed time, a clock, a vehicle speed, a language selection, a display control/menu command, a control module response to a display control command,

Some of the selectable features may be selected via a menu 26 having a first configuration containing a plurality of menu items 28. The menu items 28 are all individually selectable by the vehicle operator through the plurality of input devices 20. As mentioned, the menu items 28 may include navigation instructions or other items relevant to any vehicle navigation system. For example, the menu items 28 may include a points of interest item, an address book item, a phone book item, an intersection destination instruction, or an add/edit destination item. The menu items 28 each may have submenu items 30, either shown on the display 18 with the menu items 28, or shown separately on the display 18 once one of the menu items 28 has been selected.

Referring now to FIG. 3, an exemplary display 18 includes a plurality of display areas 21-1 to 21-4. The display areas 21-1, 21-2 display icons and/or text representing warnings and/or notifications. Either the icons or the background of areas 21-1, 21-2 may be red and yellow respectively. The display area 21-3 displays features that may be selected during manufacture or by the vehicle operator. The display area 21-4 may include an icon for a less commonly used transmission gear, such as second gear, which may be represented as D2 or simply 2. The icon or the background of 21-4 may be white.

An area 25 that is not part of the display 18 but is in close proximity thereto may include statically screened letters on the instrument cluster that represent transmission gears. The area may also include an arrow 27 or other indicator that points to display area 21-4 when an alternative gear is being used.

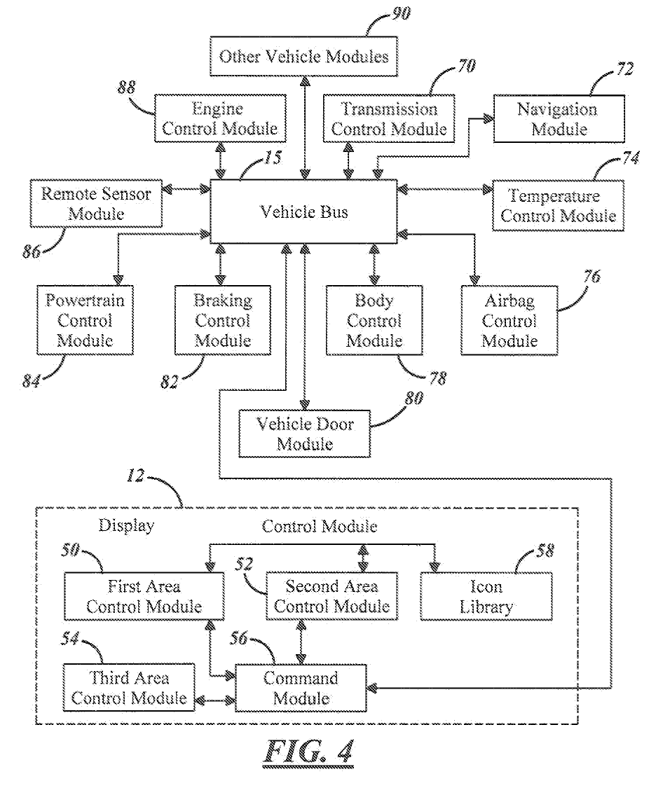

Referring now to FIG. 4 and 5A-5H, the display control module 12 may include a first, second and third area control modules 50, 52, 54 to control respective first, second, and third display areas 21-1, 21-2, 21-3. The display control module 12 may also include a command module 58 that may signal any or all of the control modules 50, 52, 54 to update respective displayed information based on signals from the vehicle bus 15.

The first and second control modules 50, 52 may select icons from the icon library 58 based on command module signals. The icon library 58 may include common automotive/easily recognizable icons, such as those in FIGS. 5A-5H that may represent that a door(s) is (are) open, the vehicle is low on gas, windshield wiper fluid is low, coolant temperature is high, and battery is low, check transmission, oil is low, tire pressure is low, respectively. Important to note is that FIGS. 5A-5H do not represent an exclusive list and various other icons are contemplated.

Further, additional icons may be added to the icon library 58 after manufacture, and the first and second control modules 50, 52 may be commanded to select the newly added icons. Icons may be added to the icon library 58 as a function of adding further vehicle systems to the vehicle 10 that communicate with the vehicle bus 15.

The vehicle bus 15 may communicate with various vehicle systems, such as, but not limited to a transmission control module 70, a navigation module 72, a temperature control, module 74, an airbag control module 76, a vehicle body control module 78, a vehicle door open/closed module 80, a braking control module 82, a powertrain control module 84, a remote sensing module 88, an engine control module 88, and other vehicle modules 90. The vehicle systems may receive and process data from electrical and/or mechanical sensing devices.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A vehicle display system comprising:
a display that includes a plurality of display areas, wherein a first display area of said plurality of display areas displays a first plurality of icons in a first color indicative of a warning and displays only one of said first plurality of icons at a time; and
a control module that selects said one of said first plurality of icons based on a vehicle condition.

2. The vehicle display system of claim 1 further comprising a second display area of said plurality of display areas that displays a second plurality of icons in a second color indicative of a warning that is different than said first color and displays only one of said second plurality of icons at a time.

3. The vehicle display system of claim 2 further comprising a third display area of said plurality of display areas that displays at least one of a plurality of selectable features.

4. The vehicle display system of claim 3 wherein said plurality of selectable features comprise at least one of a compass, a temperature, an odometer, a radio station, an average fuel economy, a distance until empty, a navigation instruction, an elapsed time, a clock, a speed, a language selection, a display control command, and a control module response to a display control command.

5. The vehicle display system of claim 1 wherein said first display area comprises a dot matrix and displays said first plurality of icons in said dot matrix.

6. The vehicle display system of claim 1 further comprising an icon library that includes said first plurality of icons, wherein said control module selects said one of said first plurality of icons from said icon library.

7. The vehicle display system of claim 1 wherein said first display area sequentially displays said one of said first plurality of icons and a second one of said first plurality of icons, wherein said control module selects said second one of said first plurality of icons based on a second vehicle condition.

8. The vehicle display system of claim 7 wherein one of said first and second vehicle conditions are indicated by an open door signal, an open trunk signal, a low fluid signal, a low tire pressure signal, a service air filter signal, a lamp condition signal, and a vehicle maintenance signal.

9. The vehicle display system of claim 8 further comprising a vehicle bus, wherein said control module receives first and second condition signals that indicate said first and second conditions from said vehicle bus.

10. A vehicle display system comprising:
a display that includes a plurality of display areas, wherein a first one of said plurality of display areas includes a pixel matrix;
an icon library that includes a first plurality of icons;
a command module that selects one of said first plurality of icons based on a first vehicle condition; and
a first control module that controls said pixel matrix based on said selection.

11. The vehicle display system of claim 10 further comprising a second display area of said plurality of display areas, wherein said icon library includes a second plurality of icons, wherein said second display area displays said second plurality of icons, wherein said first and second display areas display said first and second pluralities of icons in first and second colors respectively, and wherein said second display area displays only one of said second plurality of icons at a time.

12. The vehicle display system of claim 11 further comprising a third display area of said plurality of display areas that displays at least one of a plurality of selectable features.

13. The vehicle display system of claim 12 wherein said plurality of selectable features comprise at least one of a compass, a temperature, an odometer, a radio station, an average fuel economy, a distance until empty, a navigation instruction, an elapsed time, a clock, a speed, a language selection, a display control command, and a control module response to a display control command.

14. The vehicle display system of claim 10 wherein said first display area sequentially displays said one of said first plurality of icons and a second one of said first plurality of icons, wherein said control module selects said second one of said first plurality of icons based on a second vehicle condition.

15. The vehicle display system of claim 14 wherein said first and second vehicle conditions are selected from the group including an open door signal, an open trunk signal, a low fluid signal, a low tire pressure signal, a service air filter signal, a lamp condition signal, and a vehicle maintenance signal.

16. The vehicle display system of claim 15 further comprising a vehicle bus, wherein said control module receives said first and second condition signals from said vehicle bus.

17. A vehicle display system comprising:
a pixel matrix display that includes first and second pixel matrix display areas, wherein said first pixel matrix display area displays a plurality of first icons in a first color indicative of a first warning, wherein said second pixel matrix display area displays a plurality of second icons in a second color indicative of a second warning that is different than said first color;
an icon library that includes said pluralities of first and second icons;
a command module that selects from said pluralities of first and second icons based on one or more vehicle conditions;
a first control module that controls said first pixel matrix display area to display one of said first plurality of icons at a time based on said selections from said command module; and
a second control module that controls said second pixel matrix display area to display one of said second plurality of icons at a time based on said selections from said command module.

18. The vehicle display system of claim 17 further comprising a third display area of said plurality of display areas, wherein said third display area displays at least one of a plurality of selectable features, wherein said command module provides updated information for said plurality of selectable features.

19. The vehicle display system of claim 17 wherein said pluralities of first and second icons differ.
